(19) United States
(12) Patent Application Publication
(10) Pub. No.: US 2007/0134385 A1
(43) Pub. Date: Jun. 14, 2007

(54) Processing method, processing device and saccharifying method for extrusion cooked beer adjunct

(76) Inventor: Dechao Shen, Zibo City (CN)

Correspondence Address: BERENATO, WHITE & STAVISH, LLC, 6550 ROCK SPRING DRIVE, SUITE 240, BETHESDA, MD, 20817, US

(21) Appl. No.: 11/604,834

(22) Filed: Nov. 28, 2006

(30) Foreign Application Priority Data
Dec. 9, 2005 (CN) 200510045328.6

(51) Int. Cl. A23L 1/00

(52) U.S. Cl. 426/516

(57) ABSTRACT

The present inventions are characterized by providing a processing device, processing method and saccharifying method for extrusion cooked beer adjunct so that the saccharification and filtration of mash for the extrusion cooked beer adjunct may be carried out smoothly in the actual production for brewing beer. As compared with the double-mash saccharifying method (including the saccharifying method with additional enzymes) applied currently now, it may omit the mash cooking procedure and the cooking kettle and put the malt grist and the grist of extrusion cooked beer adjunct together into water in the brew kettle or the grist of extrusion cooked beer adjunct, malt grist and water are together put into the brew kettle to carry out the saccharifying. The single-mash saccharifying method of this invention may reduce the energy consumption, decrease the cost of beer production, increase the recoverable ratio of wort extract and raise the beer output.

### FIELD OF THE INVENTION

This invention relates generally to the field of brewing beer. Specifically, this invention relates to a processing method , processing device and saccharifying method for extrusion cooked beer adjunct.

### BACKGROUND OF THE INVENTION

The international researchers studied the extrusion cooking of beer adjunct from early 1980's to early 1990's all the time. They have found that the extrusion cooked beer adjunct makes the recoverable ratio of wort extract increased, the fermentation period of wort decreased, the malt consumption reduced and the cost of beer production decreased in production for brewing beer, while the traditional cooking kettle and cooking procedure for beer adjunct are omitted. Therefore the researchers at home and abroad have wide interest in this technology. But the saccharification and filtration of wort for above extrusion cooked beer adjunct were carried on hardly. Finally this study was suspended. Meanwhile the use of enzyme preparations in reduction of cost of beer production is to be further studied. (D. E. Briggs, etc. The Use of Extruded Barley, Wheat and Maize as Adjuncts in Mashing. Journal of the Institute of Brewing. 1986, 92: 468-474; C. J. Dale, etc. Extruded Grain Sorghum as a Brewing Raw Material. Journal of the Institute of Brewing. 1989, Vol. 95: 157-167; J. A. Delcour, etc. Unmalted Cereal Products for Beer Brewing. Part I. The Use of High Percentages of Regular Corn Starch and Grain sorghum. Journal of the Institute of Brewing, July-August, 1989, Vol. 95:271-276; Wang Zhao. The use of extruded adjunct in brewing beer. Liquor-making Science & Technology [J], 1998, (4):81; Bi Decheng. Use of extrusion technology in production of beer with high adjunct ratio [J]. Guangzhou Food Science & Technology. 1999, 12(4): 8-9, 30). K. T. Westwood (1994) pointed out: . . . , however, that in spite of extensive efforts, technical difficulties arising from the use of extruded cereals in brewing (high and unacceptable wort viscosities) have not been overcome to date. As a consequence, as far as the author is aware, extruded cereal adjuncts are not being used in the brewing beer industry. (N. D. Frame. The Technology of Extrusion Cooking. Printed in Great Britain by St. Edimundsbury Press, 1994:237-250).

As far as we know now, the extrusion cooked beer adjunct is not being applied to brewing beer.

In order to resolve the above disadvantages according to prior art, Shen Dechao put forward a processing method, processing device and saccharifying method for extrusion expanded beer adjunct (CN 00122033.0). The difficulty in saccharification and filtration of mash arising from the use of extrusion expanded beer adjunct in saccharifying was solved basically. However, the extrusion expanded beer adjunct obtained from the patented method mentioned above cannot be applied to actual production for brewing beer successfully now. The main reasons are as follows.

1. In the processing device for extrusion expanding beer adjunct according to CN 00122033.0 there are not shown the main reasonable parameters, such as the relationship of the helix angle and direction between the continuous helix on internal surface of the whole barrel and the helix on external surface of the whole screw, the compression ratio of whole screw, the ratio of length to diameter of whole screw and the volume between the end surface of the small end of the third screw and the internal surface of die plate, and so the adjunct extruded in the processing device for extrusion cooking beer adjunct cannot be moved smoothly in the extruder. Sometimes the beer adjunct extruded in the extruder cannot be extruded from the nozzle of the die plate successfully. Finally, the extruder can not be operated.

2. The barrel temperature and screw speed in the processing method for extrusion expanding beer adjunct according to CN 00122033.0 are not within the reasonable range. The combined action of mixing, stirring, frictionizing , shoving, and shearing on the beer adjunct in the extruder during the actual production can not obtain the effects of fully destroying the hydrogen bond among starch molecules of the beer adjunct. So the starch molecules can not be degraded into oligose and dextrin. This makes the mash very viscous. It is difficult to be saccharified and filtered, therefore, the extrusion expanded beer adjunct is not applicable to the actual production for brewing beer.

3. In the saccharifying method for the extrusion expanded beer adjunct according to CN 00122033.0, it is not indicated that one or several kinds of high temperature resistant α-amylase, middle temperature α-amylase, amyloglucosidase, protease, complex enzyme and calcium ion etc., have to be added into the mash, when the ratio of the amount of extrusion expanded beer adjunct to the sum of the amounts of extrusion expanded beer adjunct and malt is higher or the quality of the malt is poor. Meanwhile the pH value of the mash must be adjusted by adding acid reagent. Thus the activities of β-amylase and α-amylase of the malt and the high temperature resistant α-amylase added in the mash can not be exerted sufficiently.

4. In the saccharifying method according to CN 00122033.0, there are not shown the rotation speed and its reasonable parameter range of the stirring blade of brew kettle when the temperature of mash is increased or maintained during the saccharifying. Thus the starch granula of extrusion expanded beer adjunct in the mash cannot contact sufficiently with many enzyme preparations in the mash and thus cannot be finally degraded into oligose and dextrin fully.

5. In the saccharifying method according to CN 00122033.0, the reasonable ratio of material to water, the temperature of the mash, the temperature rise range and the time interval of maintaining the temperature of the mash during the saccharifying are all not determined reasonably. Therefore, the iodine detecting of mash is not passed through, the complete saccharification is not obtained and the filtration of mash is very hard, when the saccharifying of mash for extrusion expanded beer adjunct is ended.

The term “extrusion expanding beer adjunct” as used in CN 00122033.0, means that the beer adjunct is converted to an expanded state by means of extrusion processing.

In fact, in the current conventional production for brewing beer, the starch of beer adjunct is degraded into the oligose and dextrin by cooking. By “extrusion cooking beer adjunct” in the present application is meant that the hydrogen bond of starch molecule of beer adjunct is broken by the extrusion processing in which the combined effect of extruding, frictionizing, mixing, stirring and shearing etc. is acted on the beer adjunct in the cavity of the extruder, and the starch of beer adjunct is degraded into oligose and dextrin. This has reached the aim of the traditional cooking procedure of beer adjunct in the conventional mashing process in which the starch molecule of beer adjunct is degraded into oligose and dextrin. Therefore, the term “extrusion cooking beer adjunct” in the present application is different from the term “extrusion expanding beer adjunct” in CN 00122033.0.

In a word, the processing method, the processing device and the saccharifying method for the extrusion expanded beer adjunct according to CN 00122033.0 have many disadvantages mentioned above. Hence, only when these disadvantages according to CN 00122033.0 are overcome further, can the extrusion cooking beer adjunct be applied to the actual production for brewing beer successfully.

### THE DETAILED DESCRIPTION OF THE INVENTION

A processing method, processing device and saccharifying method for extrusion cooked beer adjunct are provided by this invention. This invention may solve the unreasonable design parameters of processing device for extrusion cooking beer adjunct, the imperfect processing method for extrusion cooking beer adjunct and the unreasonable parameter ranges of saccharifying method for the extrusion cooked beer adjunct according to CN 00122033.0. Therefore, the extrusion cooking beer adjunct of this invention may be applied to the actual production for brewing beer successfully.

For reaching the object of solving above disadvantages according to CN 00122033.0, the following technical solutions are provided by the present application.

1. The processing device for extrusion cooking beer adjunct, which comprises a whole barrel and a whole screw basically. The whole barrel is bisected in the axial direction of the whole barrel comprising the first barrel 2, the second barrel 4, the third barrel 5 and the fourth barrel 7, in which each barrel is bisected respectively in its axial direction of each barrel. In the whole barrel there are the main axis 15, the first screw 1, the second screw 6 and the third screw 10, in which each screw is installed on the main axis 15 and rotated along with the main axis 15. The outside of the first barrel 2 is not heated or cooled. The second barrel 4, the third barrel 5 and the fourth barrel 7 are heated by hot vapor or electricity or cooled by cooling water or forced air. The temperature of the each barrel can be adjusted automatically. This invention has the following features and characteristics.

The helix angle of external helix on the second screw 6 and the third screw 10 is equal approximately to the helix angle of continuous internal helix on the internal surface of the second barrel 4, the third barrel 5 and the fourth barrel 7, but their helix direction is opposite. The compression ratio of the whole screw is 10 to 30. The ratio of the length to the diameter of the screw is 6 to 15. The diameter of die nozzle 9 is φ4 mm to φ20 mm and may be adjusted. The volume between the end surface of the small end of the third screw 10 and the internal surface of die plate 8 is 0.8 to 4 times the volume of materials being pushed out by the small end of the third screw 10 when the small end of the third screw 10 is rotated at one revolution.

2. The reasonable parameters of the processing method for extrusion cooking beer adjunct according to this invention are as follows.

The moisture content percentage of beer adjunct before extrusion cooking is less than 15%. The grist diameter of above beer adjunct after being crushed is 0.65 mm to 2.0 mm. Then the water is added and the moisture content percentage of the above beer adjunct will be 10% to 30%. The above beer adjunct grist is to be processed by the above processing device for extrusion cooking beer adjunct. The first barrel 2 is not heated or cooled. The temperatures in the second barrel 4, the third barrel 5 and the fourth barrel 7 are 25° C. to 55° C., 35° C. to 70° C. and 60° C. to 95° C. respectively, which may be adjusted automatically. The rotation speed of the whole screw consisting of the first screw 1, the second screw 6 and the third screw 10 installed on the main axis 15 is 70 rpm to 169 rpm. The rotation speed of the whole screw may be adjusted. The beer adjunct is extruded from the nozzle 9 of die plate 8 finally. Then the extrusion cooked beer adjunct is cooled to the room temperature and milled. The diameter of extrusion cooked beer adjunct is 0.9 mm to 2.0 mm after being milled.

3. The saccharifying method according to this invention is as follows.

The grist of above extrusion cooked beer adjunct and malt grist are together put into water of the brew kettle at water temperature of 36° C. to 51° C. or the grist of above extrusion cooked beer adjunct, malt grist and water are together put into the brew kettle, then the mash comprising the grist of extrusion cooked beer adjunct, malt grist and water is heated to the temperature of 36° C. to 51° C., with ratio of material to water of 1:3.0 to 1:4.4. One or several kinds of high temperature-resistant α-amylase, middle temperature α-amylase, amyloglucosidase, protease, complex enzyme, calcium ion and acid reagent etc. must be added, when the ratio of the weight of extrusion cooked beer adjunct to the sum of the weight of extrusion cooked beer adjunct and malt is higher or the quality of the malt is poor. The pH value of mash is adjusted to 4.5 to 7.2. The mash is maintained at the temperature of 36° C. to 51° C. for 2 min. to 15 min.. The above mash is heated to 43° C. to 57° C. and maintained at this temperature for 55 min. to 65 min.. Then the mash is heated to 57° C. to 67° C. and is maintained at this temperature for 10 min. to 80 min. Then the mash is heated to 70° C. to 74° C. and maintained at this temperature for 3 min. to 30 min., in which if the iodine detection of above mash is passed through, the mash will be heated to the temperature of 73° C. to 80° C. and filtered at this temperature.

The above extrusion cooked beer adjuncts include one or several kinds of extrusion cooked materials such as rice, degermed maize, germed maize, grain sorghum, barley and wheat etc.

This invention has the following advantages over CN 00122033.0:

1. The main reasonable parameters, such as the relationship of the helix angle and direction between the helix on the external surface of the whole screw and the continuous helix on the internal surface of the whole barrel, the compression ratio of the whole screw, the ratio of length to diameter of the whole screw, the volume between the end surface of the small end of the third screw 10 and the internal surface of die plate 8 and the diameter of die nozzle 9 are determined in the processing device for extrusion cooking beer adjunct according to this invention. The above parameters are not mentioned in the prior art. So the motion of materials in the cavity of the extruder is smooth and the materials in cavity of the extruder are extruded from the nozzles successfully. Therefore the processing device according to this invention can be operated normally in the actual production of extruded beer adjunct.

2. This invention has pointed out the unreasonable ranges of the temperature of each barrel and the rotation speed of the whole screw and determined the reasonable ranges of above parameters. The above reasonable parameter ranges result in that the starch of extrusion cooked beer adjunct can be degraded into oligose and dextrin. The saccharification and filtration of mash for extrusion cooked beer adjunct may be carried out successfully in the actual production for brewing beer.

3. On the basis of a lot of experimental studies, this invention has provided the rotation speed of the stirring blade in the brew kettle and its reasonable parameter range when the mash being heated and the temperature of mash being maintained, which the prior art does not mention. The grist of extrusion cooked beer adjunct in the mash may be contacted with all kinds of enzymes sufficiently when the stirring blade is rotated, which may urge the starch molecules of extrusion cooked beer adjunct to be degraded into oligose and dextrin.

4. The saccharifying method according to this invention is called as the single-mash saccharifying method. As compared with the double-mash saccharifying method applied currently now, it may omit the mash cooking procedure (including the saccharifying method with additional enzymes) and cooking kettle and put the malt grist and grist of extrusion cooked beer adjunct together into water in the brew kettle to carry out the saccharifying. This invention may reduce the energy consumption, simplify the current conventional saccharification process and increase the recoverable ratio of mash extract and beer output by at least 3%.

### BRIEF DESCRIPTION OF THE DRAWINGS

FIG. 1 is the front view of the processing device for extrusion cooking beer adjunct according to this invention.

FIG. 2 is the half-sectional view of the top view of the processing device according to this invention.

### EXAMPLES

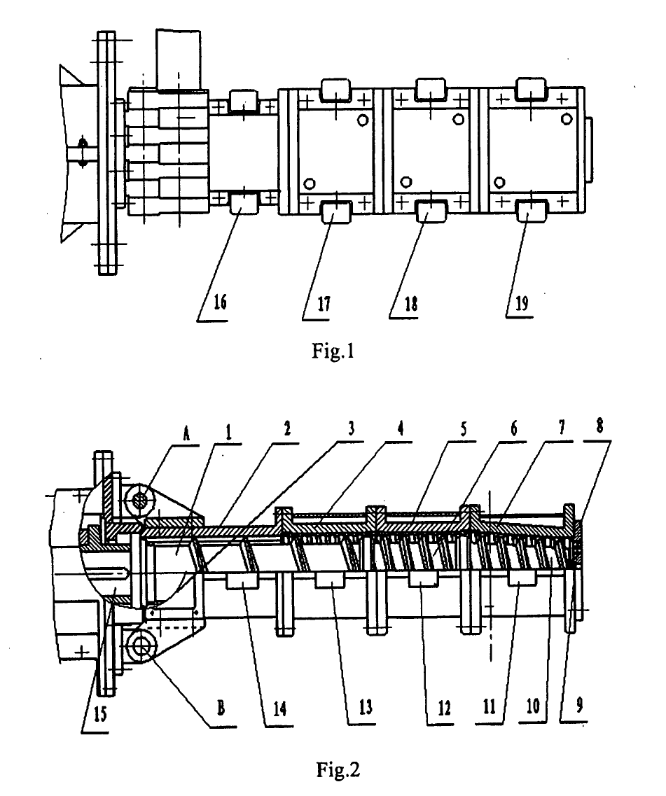

A processing device for extrusion cooked beer adjunct according to this invention Referring to FIG. 1 and FIG. 2, the processing device for extrusion cooking beer adjunct according to this invention comprises a whole barrel and a whole screw basically. The whole barrel is bisected in the axial direction of the whole barrel comprising the first barrel 2, the second barrel 4, the third barrel 5 and the fourth barrel 7, in which each barrel is bisected respectively in its axial direction. The helix on the internal surface of the whole barrel bisected is continuous. During the operation the top and lower parts of the whole barrel are fastened respectively by the clamp 14, the clamp 16, the clamp 13, the clamp 17, the clamp 12, the clamp 18, the clamp 11 and the clamp 19.

In the whole barrel there is a main axis 15, on which the first screw 1, the second screw 6 and the third screw 10 are installed and rotated along with the main axis 15.

The die plate 8, the clamp 11, the clamp 19, the clamp 12, the clamp 18, the clamp 13, the clamp 17, the clamp 14 and the clamp 16 are dismantled when inspecting the external surfaces of the first screw 1, the second screw 6 and the third screw 10 and the internal surfaces of the first barrel 2, the second barrel 4, the third barrel 5 and the fourth barrel 7. Then each of two bisected whole parts of the whole barrel which comprises the first barrel 2, the second barrel 4, the third barrel 5 and the fourth barrel 7 is rotated outwards respectively around the turn axis A and the turn axis B. Thus the whole barrel is separated in the axial direction. The outside of the first barrel 2 is not heated or cooled. The second barrel 4, the third barrel 5 and the fourth barrel 7 are heated by hot vapor or electricity or cooled by cooling water or forced air. The temperature of each barrel can be adjusted automatically.

The helix angle of external helix on the second screw 6 and the third screw 10 in the main axis 15 is equal approximately to the helix angle of continuous internal helix on the internal surface of the second barrel 4, the third barrels 5 and the fourth barrel 7, but their helix direction is opposite. The volume between the end surface of the small end of the third screw 10 and the internal surface of die plate 8 is 0.8 to 4 times the volume of materials being pushed out by the small end of the third screw 10 when the small end of the third screw 10 is rotated at one revolution. The compression ratio of the whole screw is 10 to 30. The ratio of the length to the diameter of screw is 6 to 15. The diameter of die nozzle 9 is φ4 mm to φ20 mm and may be adjusted.

A Processing Method for Extrusion Cooked Beer Adjunct According to this Invention

In the operating state, the first screw 1, the second screw 6 and the third screw 10 are installed on the main axis 15 and rotated along with the main axis 15. The rotation speed of the whole screw is 70 rpm to 169 rpm. The extrusion cooked beer adjuncts include one or several kinds of the extrusion cooked materials, such as rice, degermed maize, germed maize, barley, wheat and grain sorghum etc. The moisture content percentage of beer adjunct before extrusion cooking is less than 15%. The grist diameter of above beer adjunct after being crushed is 0.65 mm to 20 mm. Then a suitable amount of the water is added so that the moisture content percentage of the above beer adjunct is 10% to 30%. The above adjunct grist is fed via the inlet 3 into the above processing device for extrusion cooking beer adjunct. The beer adjunct is in the cavity of the extruder defined by the external surface of the first screw 1, the second screw 6 and the third screw 10, and the internal surface of the first barrel 2, the second barrel 4, the third barrel 5 and the fourth barrel 7. The first screw 1, the second screw 6 and the third screw 10 are rotated along with the main axis 15, while the materials are extruded to move towards the die plate 8. The first barrel 2 is not heated or cooled. The external surfaces of second barrel 4, the third barrel 5 and the fourth barrel 7 are heated by hot vapor or electricity or cooled by cooling water or forced air. The temperature of each barrel can be adjusted automatically. The temperatures of the second barrel 4, the third barrel 5 and the fourth barrel 7 are 25° C. to 55° C., 35° C. to 70° C., 60° C. to 95° C. respectively, which may be adjusted automatically. The beer adjunct in the cavity of the extruder is heated or cooled by the barrels through heat transfer. The diameter of die nozzle 9 is adjustable between φ4 mm to φ20 mm. The beer adjunct in the above cavity is extruded from the die nozzle 9 and formed into a porous cylindrical structure. Then the extrusion cooked beer adjunct is cooled to the room temperature and milled to the diameter of 0.9 mm to 20 mm.

A Saccharifying Method for Extrusion Cooked Beer Adjunct According to this Invention

The grist of above extrusion cooking beer adjunct and malt grist are together put into water of the brew kettle at water temperature of 36° C. to 51° C. or the grist of above extrusion cooking beer adjunct, malt grist and water are together put into the brew kettle, then the mash of the grist of extrusion cooking beer adjunct, malt grist and water is heated to the temperature of 36° C. to 51° C., with ratio of material to water of 1:3.0 to 1:4.4. One or several kinds of high temperature resistant α-amylase, middle temperature α-amylase, amyloglucosidase, protease, complex enzyme, calcium ion and acid reagent etc. must be added, when the ratio of the weight of extrusion cooking beer adjunct to the sum of weight of the grist of extrusion cooked beer adjunct and malt grist is higher or the quality of the malt is poor. The pH value of mash is adjusted to 4.5 to 7.2. So the activities of α-amylase and β-amylase of malt and high temperature-resistant α-amylase added in the mash may be exerted fully. The mash is maintained at the temperature of 36° C. to 51° C. for 2 min. to 15 min. The above mash is heated to 43° C. to 57° C. and maintained at this temperature for 55 min. to 65 min. Then the mash is heated to 57° C. to 67° C. and is maintained at this temperature for 10 min. to 80 min. Then the mash is heated to 70° C. to 74° C. and maintained at this temperature for 3 min. to 30 min., in which if the iodine detection of above mash is passed through, the mash will be heated to the temperature of 73° C. to 80° C. and filtered at this temperature.

During the rising of temperature in the saccharifying, the rotation speed of the stirring blade in the brew kettle is 10 rpm. to 80 rpm. While the temperature of the mash is maintained, the rotation speed of the stirring blade is 5 rpm. to 50 rpm.

### Example

The Processing Device for Extrusion Cooked Beer Adjunct According to this Invention

A processing device was used for extrusion cooking of beer adjunct , in which the helix angle of external helix on the second screw 6 and the third screw 10 and the helix angle of continuous internal helix on the internal surface of the second barrel 4, the third barrels 5 and the fourth barrel 7 are equal approximately to 11° to 14°, but their helix direction is opposite.

The volume between the end surface of the small end of the third screw 10 and the internal surface of die plate 8 is 2 times the volume of materials being pushed out by the small end of the third screw 10 when the end surface of small end of the third screw 10 is rotated at one revolution.
The compression ratio of the whole screw is 17 to 20.
The ratio of the length to the diameter of screw is 8.
The diameter of die nozzle 9 is φ14 mm.
   The Processing Method for Extrusion Cooked Beer Adjunct According to this Invention

The beer adjunct grist used in this example was extrusion cooked rice grist. The moisture content percentage of beer adjunct before extrusion cooking was less than 15%. The grist diameter of above beer adjunct after being crushed was 0.65 mm to 2.0 mm. Then a suitable amount of the water was added so that the moisture content percentage of the above beer adjunct was 18% to 22%.

The above adjunct grist was fed via the inlet 3 into above processing device for extrusion cooking of beer adjunct, in which the rotation speed of the whole screw was 135 rpm to 140 rpm. The first barrel 2 was not heated or cooled. The temperatures of the second barrel 4, the third barrel 5 and the fourth barrel 7 were 32° C. to 35° C., 45° C. to 47° C., 65° C. to 70° C. respectively, which may be adjusted automatically. The beer adjunct in the extruder was extruded from the die nozzle 9 and formed into a porous cylindrical structure finally. Then the extrusion cooked beer adjunct was cooled to the room temperature and milled to the diameter of 0.9 mm to 2.0 mm.

The Saccharifying Method for Extrusion Cooked Beer Adjunct According to this Invention

The grist of above extrusion cooked beer adjunct and malt grist were together put into water in a brew kettle having a water temperature of 48° C., with ratio of the grist of extrusion cooked beer adjunct and malt grist to water of 1:4.0. A suitable amount of high temperature resistant α-amylase, calcium ion (such as gypsum) and acid reagent must be added, when the ratio of the weight of extrusion cooked beer adjunct grist to the sum of weight of the grist of extrusion cooked beer adjunct and malt grist was higher or the quality of the malt was poor. The pH value of mash was adjusted to 5.4 to 5.6. So the activities of α-amylase and β-amylase of malt and high temperature-resistant α-amylase added in the mash may be exerted fully.

The mash is maintained at a temperature of 48° C. for 60 minutes. Then the mash was heated to 63° C. and maintained at this temperature for 50 minutes. Then the mash was heated to 71° C. and maintained at this temperature for 15 minutes. The iodine detection of the mash was passed through, the mash was heated to 78° C. and filtered at this temperature.

During the rising of mash temperature in the saccharifying, the rotation speed of the stirring blade of the brew kettle was 35 rpm. While the temperature of the mash was maintained, the rotation speed of the stirring blade is 15 rpm.

The measuring result of above wort after saccharifying is shown in Table 1.

TABLE 1
The measuring results of above wort after saccharifying

| | | | | α -amino | | | |
|---|---|---|---|---|---|---|---|
| | malt sugar | concentration | | nitrogen | total acid | iodine | recoverable ratio of |
| | (g/L) | (%) | pH value | (mg/L) | (mL/100 mL) | value | wort extract (%) |
| EW | 94.7 | 11.15 | 5.41 | 172 | 1.00 | 0.37 | 63.5 |
| NEW | 87.0 | 10.70 | 5.21 | 183 | 0.90 | 0.70 | 57.5 |

Note:
1. In the table 1, the EW means the wort of single-mash saccharifying of this invention for extrusion cooked rice beer adjunct.
2. The NEW means the wort of traditional double-mash saccharifying for non-extrusion cooked rice adjunct in the table 1.

The data in the Table 1 are shown the malt sugar and the concentration of wort and the recoverable ratio of wort extract for extrusion cooked rice beer adjunct are more than that for the traditional non-extrusion cooked rice beer adjunct, but the iodine value of wort for extrusion cooked rice beer adjunct is less than that for non-extrusion cooked rice beer adjunct. Contrast with non-extrusion cooked rice beer adjunct, the data in Table 1 indicate that the starch of extrusion cooked rice beer adjunct is apt to degrade into oligose and dextrine.

The extrusion cooked beer adjunct according to this invention is also applied to the production of sugar syrup, starch sugar, alcohol and white wine.

What we claim is:

1. A processing device for extrusion cooked beer adjunct consisting of a whole barrel bisected in its axial direction and a whole screw characterized by:
(a) the helix angle of external helix on the second screw 6 and the third screw 10 installed on the main axis 15 of the whole screw is approximately equal to the helix angle of continuous internal helix on the internal surface of the second barrel 4, the third barrel 5 and the fourth barrel 7 of the whole barrel, with their helix directions being opposite;
(b) the volume between the end surface of the small end of the third screw 10 and the internal surface of the die plate 8 is 0.8 to 4 times the volume of materials being pushed out by the small end of the third screw 10 when the small end of the third screw 10 is rotated at one revolution;
(c) the diameter of die nozzle 9 in the die plate 8 can be adjusted between φ4 mm to φ20 mm;
(d) the compression ratio of the whole screw is 10 to 30;
(e) the ratio of the length to the diameter of the whole screw is 6 to 15.

2. A processing method for extrusion cooked beer adjunct, which comprises the following steps:
(a) crushing a beer adjunct having a moisture content percentage of less than 15% to obtain a beer adjunct having a particle size of 0.65 mm-20 mm;
(b) adjusting the moisture content percentage of the above obtained beer adjunct to be 10%-30%;
(c) extrusion cooking the beer adjunct from step (b) in the processing device according to claim 1, wherein the first barrel 2 is not heated or cooled, the temperatures in the second barrel 4, the third barrel 5 and the fourth barrel 7 are adjusted automatically to 25° C.-55° C., 35° C.-70° C. and 60° C.-95° C. respectively, and the rotation speed of the whole screw consisting of the first screw 1, the second screw 6 and the third screw 10 installed on the main axis 15 is adjusted to 70 rpm-169 rpm;
(d) extruding the beer adjunct from the nozzle 9 of die plate 8 to obtain an extrusion cooked beer adjunct;
(e) cooling the extrusion cooked beer adjunct to room temperature; and
(f) milling the cooled beer adjunct to a particle size of 0.9 mm-20 mm.

3. An extrusion cooked beer adjunct prepared by means of the processing method according to claim 2, characterized by the extrusion cooked beer adjunct comprising one or several kinds of the extrusion cooked materials, such as the rice, the degermed maize, the germed maize, the barley, the wheat and the grain sorghum etc.

4. A saccharifying method for extrusion cooked beer adjunct according to claim 3, which comprises the following steps:
(a) putting the grist of extrusion cooked beer adjunct and malt grist together into water having a temperature of 36° C. to 51° C. in a brew kettle with a ratio of beer adjunct and malt grist to water of 1:3.0 to 1:4.4; or
putting the grist of extrusion cooked beer adjunct, malt grist and water together into a brew kettle at a ratio of beer adjunct plus malt grist to water of 1:3.0 to 1:4.4 to obtain a mash, and heating the mash to a temperature of 36° C. to 51° C.;
(b) adding one or several kinds of high temperature-resistant α-amylase, middle temperature α-amylase, amyloglucosidase, protease, complex enzyme, calcium ion and acid reagent etc. into the brew kettle when the ratio of the weight of extrusion cooked beer adjunct to the sum of the weight of extrusion cooked beer adjunct and malt is higher or the quality of the malt is poor;
(c) adjusting the pH value of above mash to 4.5 to 7.2 by adding acid reagent into the above mash and maintaining the mash at the temperature of 36° C. to 51° C. for 3 min. to 15 min.;
(d) heating the above mash to a temperature of 43° C. to 57° C. and maintaining at this temperature for 55 min. to 65 min.;
(e) heating the above mash to a temperature of 57° C. to 67° C. and maintained at this temperature for 20 min. to 80 min.; and
(f) heating the above mash to the temperature of 70° C. to 74° C. and maintaining at this temperature for 3 min. to 30 min. ,in which if the iodine detection of above mash is passed through, the mash will be heated to the temperature of 73° C. to 80° C. and filtered at this temperature;
wherein during the rising of temperature of mash in the saccharifying the rotation speed of the stirring blade in the brew kettle is 10 rpm. to 80 rpm. and during the maintaining of temperature of mash in the saccharifying the rotation speed of the stirring blade in the brew kettle is 5 rpm. to 50 rpm.
